(19) United States
(12) Patent Application Publication
(10) Pub. No.: US 2003/0208434 A1
(43) Pub. Date: Nov. 6, 2003

(54) On-line system and method for analyzing vendor proposals in response to a request-for-proposal

(76) Inventor: Enrique Posner, New York, NY (US)

Correspondence Address: Joseph Sofer, SOFER & HAROUN, L.L.P., Suite 1921, 342 Madison Avenue, New York, NY, 10173, US

(21) Appl. No.: 09/754,821

(22) Filed: Jan. 4, 2001

Related U.S. Application Data
(60) Provisional application No. 60/211,719, filed on Jun. 15, 2000.

(51) Int. Cl. G06F 17/60

(52) U.S. Cl. 705/37; 705/80; 705/7

(57) ABSTRACT

An on-line system and method for analyzing proposals received in response to a request-for-proposal for highly specialized or engineered goods. The system comprises a purchaser terminal and a vendor terminal. A processor is coupled to the purchaser terminal and to the vendor terminal via Internet. The processor is configured to receive a bid from the vendor terminal, wherein the bid comprises a plurality of bid sections. The processor automatically transmits, via e-mail, the bid sections to predetermined users of the purchaser terminal. Advantageously, each one of the bid sections corresponds to a sections of a request-for-proposal generated by a purchaser, and is transmitted to the RFP team members that created the RFP section. The processor may also comprise a negotiation module which is configured to display to users of the purchaser terminal and the vendor terminal offer and counteroffer information. A template manager module is configured to provide a purchase order template, which is automatically populated with information from the RFP sections and from the negotiation module, and to provide an invoice template, which is also automatically populated with information from the RFP sections and from the negotiation module.

### CROSS-REFERENCE TO RELATED APPLICATIONS

This application claims the benefit of priority of U.S. Provisional Patent Application Serial No. 60/211,719, filed on Jun. 15, 2000, and is related to Applicant's co-pending applications, identified as Attorney Docket Nos. 878-006, 878-007, 878-008 and 878-011. Each of these applications, including the above-referenced provisional application, is incorporated by reference herein as fully as if set forth in its entirety.

### FIELD OF THE INVENTION

This invention relates to a system and method for processing and managing data corresponding to RFP's (“requests-for-proposal”), and more particularly, to an on-line system and method for analyzing proposals received in response to an RFP for highly specialized goods.

### BACKGROUND OF THE INVENTION

Many goods which are purchased by a large industrial entity (e.g.—utility and/or energy companies) may be purchased over-the-counter. These type of goods are typically employed by the industrial facility for the maintenance, repair and operation of the facility, and are often referred to as “MRO” products. Since these products are relatively common, they may be purchased from a catalog. Alternatively, they may be purchased on-line in the typical fashion, whereby a user visits the website of a vendor and orders the product described on the website.

However, there are many goods which can not be purchased over-the-counter by a large industrial entity. Highly engineered goods typically fall into this category, as they are very often required by an industrial entity but can not be purchased in the typical on-line fashion described above. Highly engineered goods, by definition, must meet an industrial entity's specific, and often unique, engineering requirements. Thus, they can not be purchased from a catalog or on-line.

Instead, highly engineered goods are typically procured by an industrial entity by creating a request-for-proposal (referred to hereinafter as an “RFP”). The RFP describes the unique engineering specifications that are required to be incorporated in the product. The RFP is then supplied to vendors that are deemed capable of manufacturing the product in accordance with the required engineering specifications. The vendors' proposals are then submitted to the industrial entity for its consideration.

While the above-described RFP system is very commonly employed by industrial entities, there is currently no system or method which provides an optimal workflow and collaboration capabilities in the creation, management and tracking of RFP's in an on-line environment. Thus, there exists a need for such a system and method.

### SUMMARY OF THE INVENTION

The present invention, in accordance with one embodiment, provides a system and method for creating, managing and tracking RFP's in an on-line environment. Although not limited thereto, the system and method of the present invention is particularly well-suited to utility and energy companies, which often require highly engineered goods made to uniquely required specifications. For the purposes of this application, the entity making an RFP is referred to hereinafter as a “purchaser”, although the present invention is not intended to be limited in scope to any particular type of purchaser, nor to any particular type of good.

In a preferred embodiment, the system comprises a network of at least one purchaser terminal for entering request data and a network of at least one vendor terminal for entering proposal data. The request data may include, but is not limited to, the name and type of product desired, the unique engineering specifications that the product must meet, as well as scheduling terms, payment terms etc. The proposal data may include, but is not limited to, the name and type of product which is available, an explanation of how the available product meets the specified engineering requirements, the price and availability of the product, etc.

The system also comprises a processor having a web server, which is configured to maintain an addressable web site for providing interfaces to users of the purchaser and vendor terminals. The processor comprises a proposal analysis module. The proposal analysis module is configured to receive and process proposals that are received from various vendors and, advantageously, to generate a proposal tabulation that identifies the vendor which is the most suitable to receive the order. The processor may also comprise a negotiation module, which is configured to enable the purchaser and vendor to communicate directly with each other via e-mail in order to negotiate the terms of the order.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings in which:

FIG. 1 is a diagram that illustrates the salient features of an on-line RFP management system, in accordance with one embodiment of the present invention;

FIG. 2 is a chart that illustrates the steps performed during the operation of the system, in accordance with one embodiment of the invention;

FIG. 3 is a flowchart that illustrates the steps that are performed when the purchaser receives the proposal, in accordance with one embodiment of the invention;

FIG. 4 is a flowchart that illustrates the steps that are performed by the purchaser and the vendor when conducting the negotiation process, in accordance with one embodiment of the invention;

FIG. 5 is a flowchart that illustrates the steps that are performed in order for the purchaser to select a vendor's proposal, in accordance with one embodiment of the invention;

FIG. 6 is a flowchart that illustrates the steps that are performed in order for the purchaser to issue a purchase order to the selected vendor, in accordance with one embodiment of the invention; and

FIG. 7 is a flowchart that illustrates the steps that are performed in order for the vendor to fulfill the purchase order, in accordance with one embodiment of the invention.

### DETAILED DESCRIPTION OF THE INVENTION

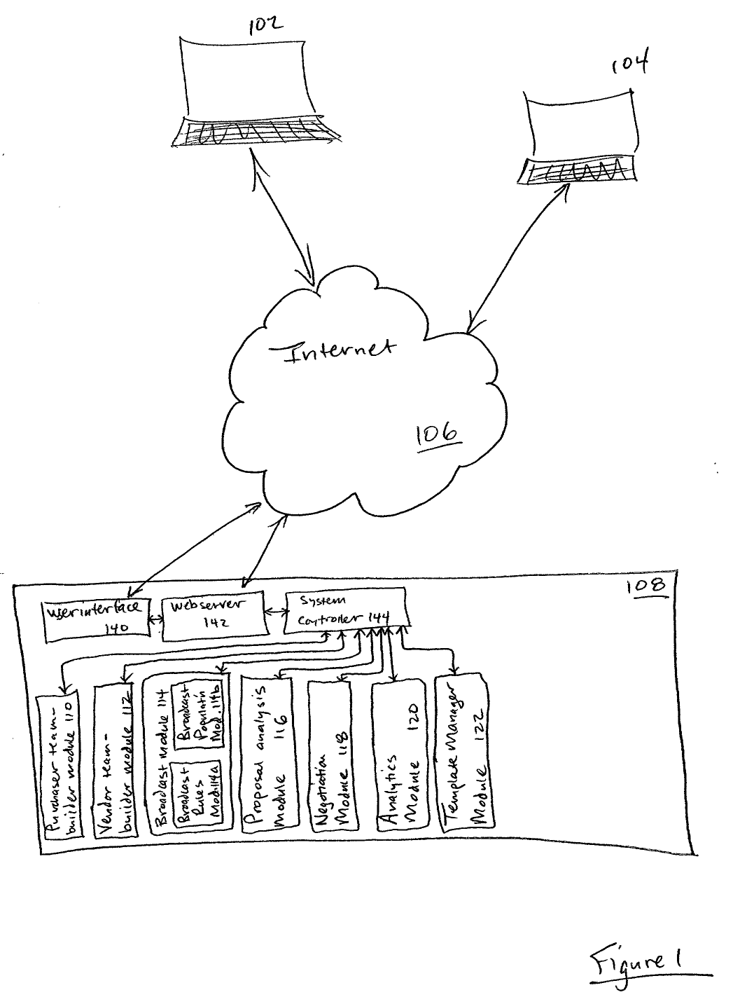

In accordance with one embodiment, the present invention is directed to a system and method for creating, managing and tracking RFP's in an on-line environment. The salient features of the present invention according to one embodiment, are shown in FIG. 1. Although not limited thereto, the present invention is advantageously employed by utility and energy companies.

FIG. 1 illustrates a communications system 100, in accordance with one embodiment of the present invention. In the embodiment shown, vendor terminal 102 and purchaser terminal 104, such as personal computers, hand-held devices or the like, are coupled to Internet 106. Also coupled to Internet 106 is processor 108.

Processor 108 comprises web server 142 which is configured to maintain an addressable web site. Processor 108 also comprises viewer display interface 140 that provides an interface for users of the computer terminals to communicate with processor 108, as will be described further below. System controller 144 is coupled to web server 142, and controls the operation of processor 108. Processor 108 also comprises modules which perform various operations (although it is noted that these modules need not be discrete components but may instead be any combination of components, or software, which provide the desired functionality described below).

According to one embodiment of the invention, processor 108 comprises purchaser team builder module 110, which is configured to receive and process request data from one or more of the purchaser terminals. Purchaser team builder module 110 provides a workflow that enables the users of the one or more purchaser terminals to collaborate in the creation of an RFP.

Processor 108 also comprises vendor team builder module 112, which is configured to receive and process proposal data from one or more of the vendor terminals. Vendor team builder module 112 provides a workflow that enables the users of the one or more purchaser terminals to collaborate in the creation of a proposal in response to the purchaser's RFP.

Processor 108 may also comprise broadcast module 114, which is configured to broadcast the requested data to a desired number of vendors. Broadcast module 114 may also comprise a broadcast rules module 114a and a broadcast population module 114b. In a preferred embodiment, the broadcast rules module 114a comprises the requirements that must be met by a particular vendor in order to receive the broadcast of an RFP. The broadcast population module 114b, on the other hand, is configured to store data corresponding to all of the vendors that may be used.

Processor 108 may also comprise proposal analysis module 116. Proposal analysis module 116 is configured to receive and process proposals that are received from various vendors and, advantageously, to generate a proposal tabulation that identifies the vendor which is the most suitable to receive the order. Processor 108 may also comprise a negotiation module 118, which is configured to enable the purchaser and vendor to communicate directly with each other via e-mail in order to negotiate the terms of the order.

In a preferred embodiment, processor 108 also comprises analytics module 120. Analytics module 120 is configured to track an order by ascertaining its progress at various stages of production. The analytic data generated by analytics module 120 may advantageously be mined for various reasons. For instance, data corresponding to a particular vendor's on-time delivery performance may be processed for use by the broadcast module 114 in order to determine whether the vendor will receive future RFP's via broadcast.

Processor 108 may also comprise template manager module 122. Template manager module 122 is configured to enable a user to either create new templates (e.g.—engineering templates, legal templates, etc.) or to select from existing templates from a template library. The templates that are generated by template manager module 122 provide a predetermined format for storing data entered by users, thereby allowing efficient storage and evaluation of pertinent RFP data.

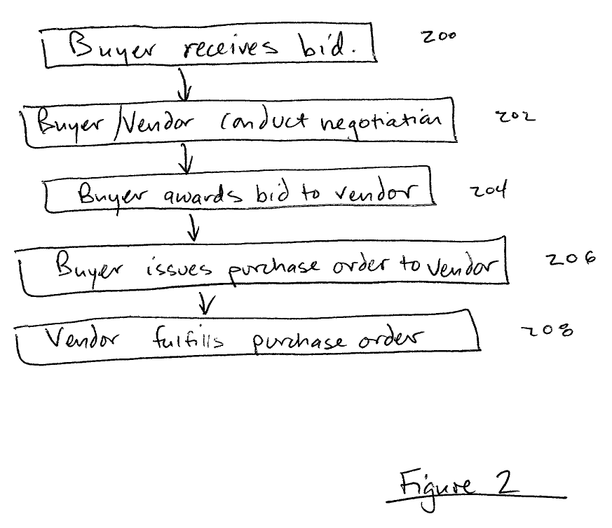

FIG. 2 is a flow chart that illustrates the steps that are performed by vendors and purchasers, in accordance with one embodiment of the invention, in order for a purchaser to analyze proposals received from vendors. It is noted that the steps that are illustrated in FIG. 2 are merely exemplary, and greater or fewer number of steps may be employed in order to accomplish the same functions as described herein. In addition, it is noted that, while some of these steps are listed in the order in which they are performed, this is not necessarily the case.

As referenced in Applicant's co-pending provisional application and Applicant's co-pending utility applications, various steps are performed before the steps shown in FIG. 2 are performed. Generally, the above-referenced co-pending applications, which are incorporated by reference herein, describe the method by which a purchaser creates a request for proposal (referred to herein as an “RFP”) for a highly specialized good and broadcasts the RFP to various vendors in order to solicit bids therefor. The applications also describe the method by which each vendor creates a proposal in response to the RFP and submits the proposal to the purchaser.

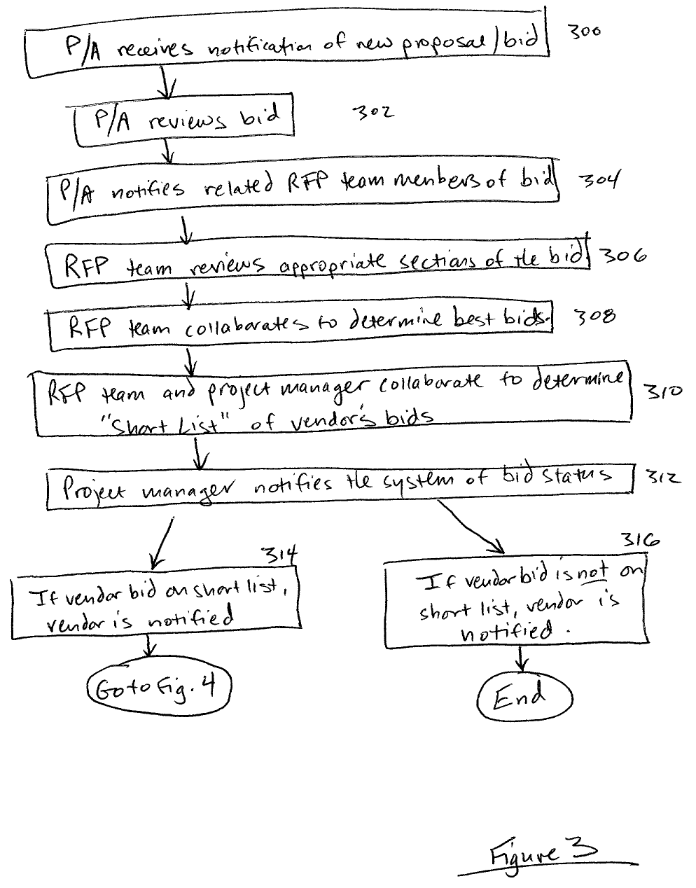

Referring now to the flowchart in FIG. 2, the present invention relates to the steps that are performed after a vendor's proposal in response to an RFP has been received by the purchaser. Advantageously, the steps are performed by proposal analysis module 116 of processor 108. At step 200, the purchaser receives the proposal. The process by which the purchaser receives the proposal is discussed in greater detail below. Specifically, FIG. 3 is a flowchart that illustrates the steps that are performed when the purchaser receives the proposal, in accordance with one embodiment of the present invention.

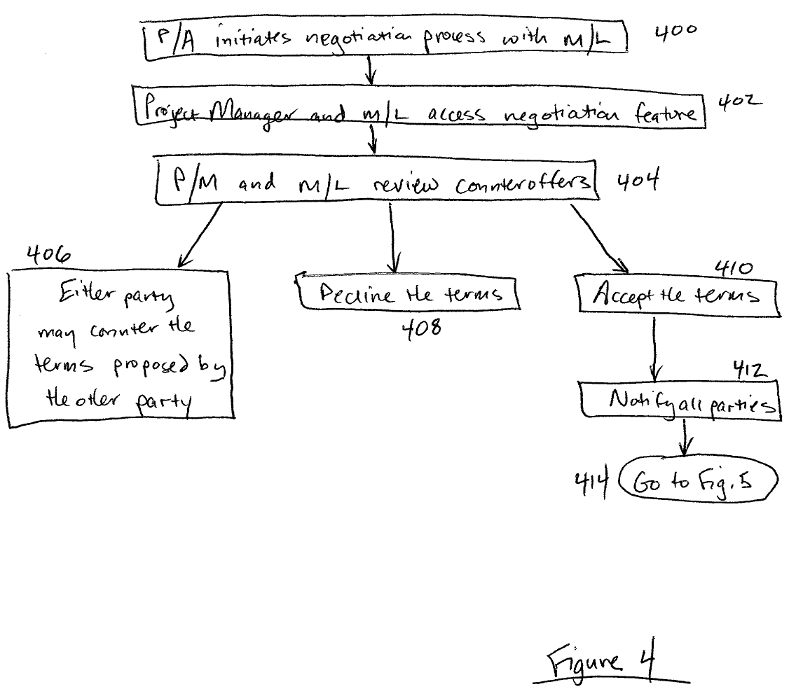

At step 202 of FIG. 2, the purchaser and the vendor conduct a negotiation process in order to finalize the terms of the agreement. The negotiation process is regulated by negotiation module 118. The process by which the purchaser and the vendor conduct the negotiation process is discussed in greater detail below. Specifically, FIG. 4 is a flowchart that illustrates the steps that are performed by the purchaser and the vendor when conducting the negotiation process, in accordance with one embodiment of the present invention.

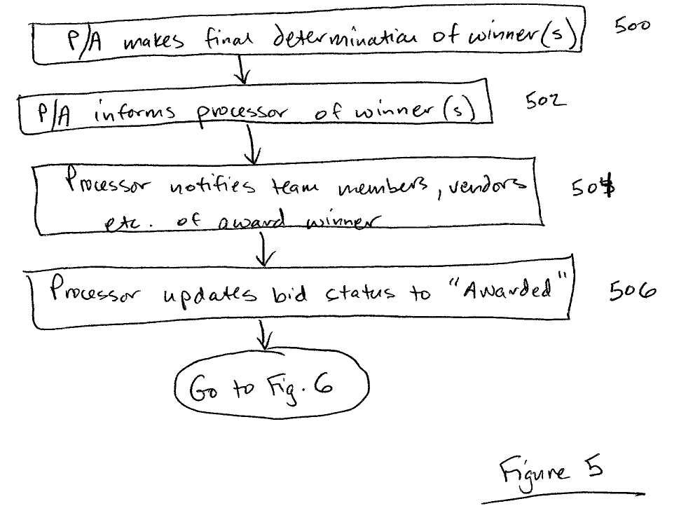

At step 204, the purchaser selects the vendor (or vendors in case of multiple award winners) having the most suitable proposal after having performed the negotiation process of step 202. The selection of the most suitable vendor proposal is advantageously performed by proposal analysis module 116, which tabulates and/or weights various aspects of each proposal. The process by which the purchaser selects a vendor's proposal is discussed in greater detail below. Specifically, FIG. 5 is a flowchart that illustrates the steps that are performed in order for the purchaser to select a vendor's proposal, in accordance with one embodiment of the present invention.

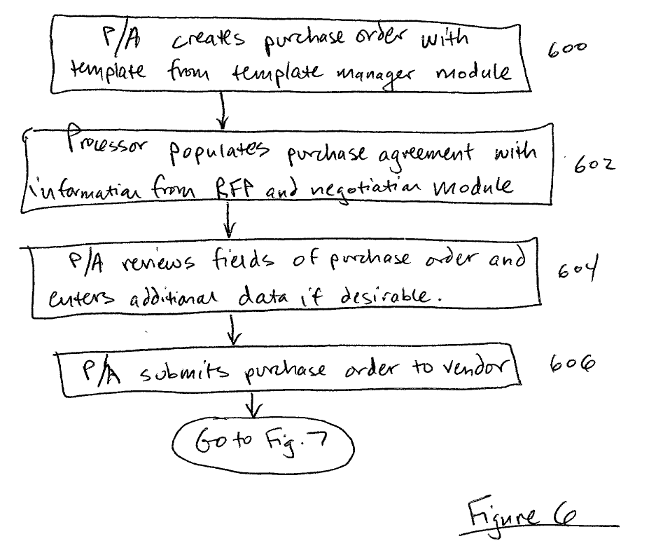

At step 206, the purchaser issues a purchase order to the selected vendor (or vendors). The process by which the purchaser issues a purchase order to the selected vendor is discussed in greater detail below. Specifically, FIG. 6 is a flowchart that illustrates the steps that are performed in order for the purchaser to issue a purchase order to the selected vendor, in accordance with one embodiment of the present invention.

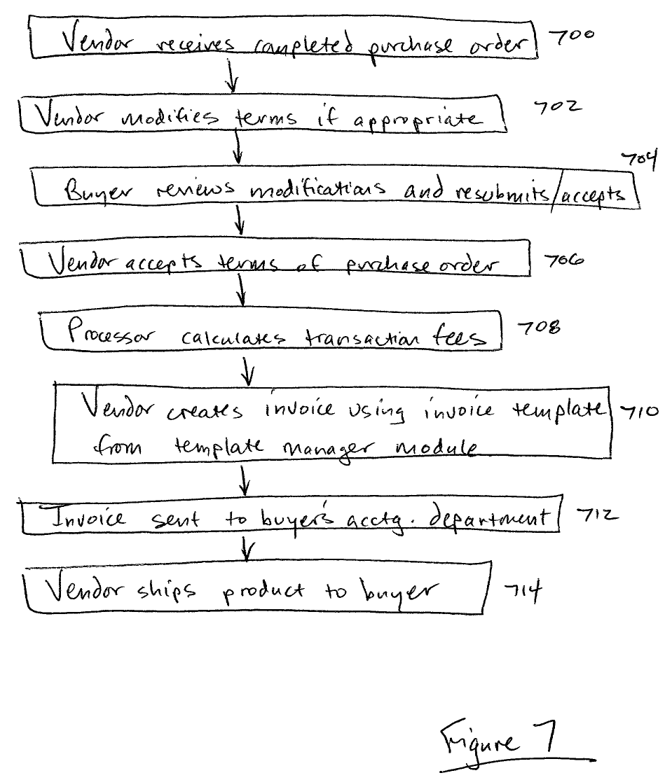

At step 208, the vendor fulfills the purchase order. The process by which the vendor fulfills the purchase order is discussed in greater detail below. Specifically, FIG. 7 is a flowchart that illustrates the steps that are performed in order for the vendor to fulfill the purchase order, in accordance with one embodiment of the present invention.

For the purposes of this application, a vendor refers to any entity within system 100 that is registered or selected to receive RFPs. These vendors can comprise various organizations that maintain specialized engineered equipment. When referring to vendors, several officials will be addressed separately that maintain different functions within the organization and thus perform different tasks within system 100.

For instance, a purchasing agent is an individual or individual that is authorized to finalize the terms of a contract and to make purchasing decisions. Marketing leads refer to the individuals in a vendor organization that make the initial decision to act on an RFP. Department heads and project managers are the individuals who perform tasks such as assigning team members and team leaders, setting up project parameters, and making final decisions on proposals. Team leaders refer to the member or members of a proposal team that organize the team members and work load and communicate with the project manager and department heads. Team members are the workers at the vendor organization who prepare the proposal, performing tasks such as entering engineering specifications for the item to be sold.

Of course, the positions mentioned above are only intended as examples for the following discussion, and in no way are they intended to limit the scope of the present invention. It is noted that the steps of this invention may be performed by one person, by many persons or, in some cases, by automated means, irrespective of the positions or titles held by the persons performing the steps.

As previously mentioned, FIG. 3 is a flowchart that illustrates the steps that are performed when the purchaser receives the proposal, in accordance with one embodiment of the present invention. At step 300, the purchasing agent receives notification of the vendor's bid. Advantageously, the notification is received via e-mail. At step 302, the purchasing agent reviews the bid. At step 304, the purchasing agent notifies the appropriate RFP team of the received bid. Although not discussed herein, Applicant's co-pending applications explain in detail the manner in which an RFP team is assembled.

At step 306, the purchaser's RFP team reviews the sections of the bid. Advantageously, those members of the purchaser's RFP team that prepared the RFP are the same members that review the sections of the bid. In other words, according to one embodiment, the RFP comprises various sections which have been contributed by purchaser team members specializing in the subject matter of the section, and the vendor's response comprises the vendor's proposed terms corresponding to each of these sections. Thus, at step 306, each section of the proposal is analyzed by a person or persons most familiar with that section.

At step 308, a group of the best bids is determined. Typically, this is performed by a collaboration between the various members of the RFP team in order to be certain that each bid satisfies the requirements for each section of the RFP. At step 310, the RFP team and the project manager determine a “Short List” of vendor bids. The short list is a list of the best bids of those received. As will be discussed in more detail below, the vendors on the short list are typically those vendors which the purchaser has confidence will reliably satisfy the order.

At step 312, the project manager enters its selection of the vendors that have made the short list. Proposal analysis module 116 then initiates contact with all of the vendors that submitted bids in response to the RFP. For instance, for each vendor that the purchaser has included on the short list, the method proceeds to step 314. At step 314, the purchaser provides a notification to the vendor that the bid is being considered. The method then proceeds to the flowchart in FIG. 4 to perform a negotiation process, as explained below. On the other hand, for each vendor that the purchaser has not included on the short list, the method proceeds to step 316. At step 316, the purchaser provides a notification to the vendor that the bid is not being considered.

As previously mentioned, FIG. 4 is a flowchart that illustrates the steps that are performed by the purchaser and the vendor when conducting a negotiation process, in accordance with one embodiment of the present invention. As mentioned above, a negotiation process ensues when a vendor's response to the RFP has been added to the purchaser's “short list” of vendors, and the terms of an agreement are to be finalized before the purchaser accepts the bid of any of these vendors.

At step 400, the purchasing agent of the purchaser initiates the negotiation process with a vendor. In one embodiment, when the negotiation process is initiated, processor 108 generates a means by which the purchaser and the vendor can communicate about specific items of the RFP and proposal. Thus, in one embodiment, processor 108 identifies and lists the specific items that the two parties have not agreed upon, displays to both the sides the offer of the other party, and provides a field or space for each party to enter a counteroffer. Typically, the negotiation process is initiated with the vendor's marketing lead. At step 402, both the purchaser's project manager and the vendor's marketing lead access the negotiate feature. It is noted that, according to one embodiment of the invention, the purchaser and the vendor do not have to access the negotiation section simultaneously—it is sufficient that they alternately access the system in order to communicate back and forth.

At step 404, the purchaser's project manager and the vendor's marketing lead review the terms that have been offered by the other party. From this step, the process may proceed to steps 406, 408 or 414. For instance, the process proceeds to step 406 if a party wishes the counter the terms proposed by the other party. Step 406 is repeated again if the other party also counters the newly proposed terms.

If the terms proposed by either the vendor or the purchaser are unacceptable to the other party, either party may decline the offer at step 408. For instance, this may occur when one party indicates that its offer is final and the other party does not agree to the terms included therein. If declined, the negotiation process between the purchaser and the vendor is terminated. When this occurs, then the purchaser may begin (or continue) negotiations with a different vendor on the “short list”.

On the other hand, the process proceeds to step 410 if the proposed terms are accepted. Step 410 may be reached immediately if both parties agree to terms immediately, or else may be reached after numerous offers and counteroffers have been proposed at step 406 by both parties. Once accepted, the process goes to step 412, at which the parties are notified that a bid has been accepted. Advantageously, this notification is made by e-mail. The parties notified may comprise the purchaser and the vendor with the accepted bid, but may also comprise any other vendor on the short list, since these vendors are entitled to know that the RFP proposal of another vendor has been accepted. Finally, upon acceptance, the process proceeds to step 414, at which processor 108 performs the steps illustrated in the flowchart shown in FIG. 5.

As previously mentioned, FIG. 5 is a flowchart that illustrates the steps that are performed in order for the purchaser to accept a vendor's proposal, in accordance with one embodiment of the present invention. In other words, these steps are performed in order for a purchaser to award a bid to a specific vendor.

At step 500, the purchasing agent of the purchaser makes a final determination of the award winners. It is noted that, according to various embodiments of the invention, there may be more than one award winner. For instance, a purchaser may decide, upon reviewing the proposals submitted by the vendors, to award a first part of the contract to one vendor and a second part of the award to another vendor.

At step 502, the purchasing agent enters in processor 108 the award winners. If there is more than one winner, the purchasing agent advantageously enters a percentage of the award for each winner. For instance, if a first vendor is awarded 60% of a project and a second vendor is awarded 40% of the project, the purchasing agent would enter both award winners with the appropriate percentages for each.

At step 504, processor 108 transmits notification e-mail messages regarding the award. Advantageously, these notification e-mail messages are provided to the purchaser's RFP team members, the vendor's team members, etc. At step 506, processor 108 changes the bid status in the system to reflect that the project is awarded. Processor 108 then proceeds to the flowchart shown in FIG. 6.

As previously mentioned, FIG. 6 is a flowchart that illustrates the steps that are performed in order for the purchaser to issue a purchase order to the selected vendor, in accordance with one embodiment of the present invention. At step 600, the purchasing agent creates a purchase order. Advantageously, the purchasing agent performs this step by accessing template manager module 122 of processor 108, which is configured to maintain at least one type of purchase order. Of course, template manager 122 may be configured to maintain many different purchase order templates having various terms, although a single purchase order template is sufficient.

At step 602, processor 108 populates the purchase order template. Preferably, information that was included in the RFP may be automatically inserted in the purchase order template. Additionally, information may be captured from the vendor's proposal or from the negotiation process and used to automatically populate the purchase order.

At step 604, the purchasing agent performs a review of the information that has been included in the purchase order template. If necessary, the purchasing agent enters information that has not already been included. Thus, advantageously, some or all of the fields of the purchase order template may be edited. At step 606, the purchasing agent submits the purchase order to the vendor.

FIG. 7 is a flowchart that illustrates the steps that are performed in order for the vendor to fulfill the purchase order, in accordance with one embodiment of the present invention. At step 700, the vendor receives the completed purchase order submitted by the purchasing agent of the purchaser at step 606 of the flowchart in FIG. 6.

At step 702, the vendor modifies the terms of the purchase order if appropriate. For instance, the purchase order template may comprise additional terms that were not part of the negotiation process. Alternatively, some modifications may be necessary if new information becomes available to the vendor. Some of these terms may include shipment dates and methods, quantity changes, minor modifications to the specifications, etc. The modified purchase order to returned to the purchaser.

At step 704, the purchaser reviews the final changes proposed by the vendor and resubmits or accepts the new terms. At step 706, the vendor accepts the final version of the purchase order. At step 708, the system calculates any transaction fees that may be appropriate. According to one embodiment of the invention, the transaction fees correspond to the value of the purchase order, although the present invention contemplates that any method may be employed to calculate transaction fees.

At step 710, the vendor creates an invoice. Preferably, the vendor accesses template manager module 122, which is configured to maintain an invoice template. The fields of the invoice template are populated by information that was also employed to populate the purchase order. At step 712, the invoice is transmitted by the vendor to the buyer's accounting department. At step 714, the vendor transmits the highly specialized item which is the subject of the purchase order to the purchaser at an address determined by both parties.

Once a product is shipped to the purchaser, the vendor may be required, depending on the terms of the purchase order, to perform additional services. These services may include installation, maintenance, monitoring, instruction, etc. Thus, processor 108 is also configured to employ additional functionality for the purposes of maintaining vendor performance metrics. These features are discussed in greater detail in Applicant's co-pending patent application, identified as Attorney Docket No. 878-009 (which as previously mentioned, is incorporated by reference herein).

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

We claim:

1. A system comprising:
a purchaser terminal;
a vendor terminal;
a processor coupled to said purchaser terminal and to said vendor terminal via Internet, wherein said processor is configured to receive a bid from said vendor terminal, said bid comprising a plurality of bid sections, and to automatically transmit via e-mail said bid sections to predetermined users of said purchaser terminal.

2. The system according to claim 1, wherein each one of said plurality of bid sections correspond to one of a plurality of sections of a request-for-proposal generated by a user of said purchaser terminal.

3. The system according to claim 2, wherein said predetermined users of said purchaser terminals correspond to RFP team members that created said RFP sections.

4. The system according to claim 3, wherein said processor further comprises a negotiation module which is configured to display to users of said purchaser terminal and said vendor terminal offer and counteroffer information.

5. The system according to claim 4, wherein said processor further comprises a template manager module which is configured to provide a purchase order template.

6. The system according to claim 5, wherein said processor is configured to automatically populate said purchase order template with information from said RFP sections.

7. The system according to claim 6, wherein said processor is further configured to automatically populate said purchase order template with information from said negotiation module.

8. The system according to claim 1, wherein said processor is further configured to calculate transaction fees corresponding to the value of a purchase order.

9. The system according to claim 5, wherein said template manager module is further configured to provide an invoice template.

10. The system according to claim 9, wherein said processor is configured to automatically populate said invoice template with information from said RFP sections and from said negotiation module.

11. A method for analyzing a proposal received in response to a request-for-proposal, said method comprising the steps of:
receiving at a processor said proposal generated at a vendor terminal, wherein said vendor terminal is coupled to said processor via Internet, and wherein said proposal comprises a plurality of proposal sections; and
by said processor, automatically transmitting via e-mail each one of said plurality of proposal sections to predetermined users of a purchaser terminal, said purchaser terminal coupled to said processor via Internet.

12. The method according to claim 11, wherein each one of said plurality of bid sections correspond to one of a plurality of sections of a request-for-proposal generated by a user of said purchaser terminal.

13. The method according to claim 12, wherein said transmitting step further comprises transmitting said plurality of bid sections to RFP team members that created said RFP sections.

14. The method according to claim 13, further comprising the step of displaying, via a negotiation module, offer and counteroffer information to users of said purchaser terminal and said vendor terminal.

15. The method according to claim 14, further comprising the step of providing, via a template manager module, a purchase order template.

16. The method according to claim 15, further comprising the step of said processor automatically populating said purchase order template with information from said RFP sections.

17. The method according to claim 16, further comprising the step of said processor automatically populating said purchase order template with information from said negotiation module.

18. The method according to claim 11, further comprising the step of calculating transaction fees corresponding to a value of a purchase order.

19. The method according to claim 15, further comprising the step of providing, via a template manager module, an invoice template.

20. The method according to claim 19, further comprising the step of said processor automatically populating said invoice template with information from said RFP sections and from said negotiation module.
